(19) United States
(12) Patent Application Publication
(10) Pub. No.: US 2010/0107992 A1
(43) Pub. Date: May 6, 2010

(54) Gentle stop retractable leash

(76) Inventor: Nathan S. Chefetz, Washington, DC (US)

Correspondence Address: Michael J. Foycik, Jr., 4235 Universtiy Drive, Fairfax, VA, 22030, US

(21) Appl. No.: 12/458,418

(22) Filed: Jul. 10, 2009

Related U.S. Application Data
(60) Provisional application No. 61/193,182, filed on Nov. 3, 2008.

(51) Int. Cl. A01K 27/00; B65H 75/34

(52) U.S. Cl. 119/796

(57) ABSTRACT

Retractable leashes use a braking mechanism to stop a dog from movement. A mechanism is provided for smoothly or gradually braking the unreeling of the line, and can include a brake with a pad or pads for stopping the dog much like a bicycle. The brake and pads allow the user to squeeze the trigger lightly or more aggressively to slow and stop the dog's movement without the sudden jerk of traditional retractable leashes. The consumer may ultimately clamp down on the trigger to clamp the pads to the reel instantly for an aggressive stop if needed.

### CROSS REFERENCE TO RELATED APPLICATIONS

This application claims the priority of Provisional Application No. 61/193,182 filed on Nov. 3, 2008, inventor Nathan S. Chefetz, entitled “Retractble leash.” The entire disclosure of this provisional patent application is hereby incorporated in its entirety by reference thereto.

### STATEMENT REGARDING FEDERALLY SPONSORED RESEARCH OR DEVELOPMENT

Not applicable.

### FIELD OF THE INVENTION

The present invention relates generally to retractable leashes for dogs or pets. Such leashes can, for example, be used for a dog or other pet. More particularly, this invention is directed to a retractable leash for smoothly stopping the unreeling of a leash when a dog or other pet is pulling away, so that the dog or other pet is not suddenly jerked to a stop.

### BACKGROUND OF THE INVENTION

Leashes are known which include a reel and a brake for controlling unwinding of the reel, together with a brake release for allowing unwinding.

Typical prior retractable leashes use a braking mechanism, for example that shown in U.S. Pat. No. 5,483,926, to stop a dog from movement. This type of mechanism can cause a sharp jerk, the magnitude of which depends on the size, speed and strength of the pet or dog.

There is a need for an apparatus or device for use in a retractable leash for smoothly stopping the unreeling of a leash when a dog or other pet is pulling away, so that the dog or other pet is not suddenly jerked to a stop.

It is accordingly a problem in the prior art to provide a device for gradually or smoothly stopping unwinding of a pet leash when a pet is pulling away, so that the pet is not suddenly jerked to a stop.

### SUMMARY OF THE INVENTION

From the foregoing, it is seen that it is a problem in the art to provide a device meeting the above requirements.

According to the present invention, a device is provided which meets the aforementioned requirements and needs in the prior art. Specifically, the device according to the present invention provides a retractable leash for smoothly stopping the unreeling of a leash when a dog or other pet is pulling away, so that the dog or other pet is not suddenly jerked to a stop.

Further according to the present invention, a second brake lock mechanism is provided as an alternative stopping mechanism. It locks the leash immediately, and does not provide a gentle stop. It is used for urgent stops, and can also be used as a backup stopping mechanism.

Other objects and advantages of the present invention will be more readily apparent from the following detailed description when read in conjunction with the accompanying drawings.

### BRIEF DESCRIPTION OF THE DRAWINGS

FIG. 1 is perspective view of a retractable leash for gradually slowing unwinding of a cord or line, according to the present invention.

FIG. 2 is a top elevational side view of the retractable leash of FIG. 1, according to the present invention.

FIG. 3 is a perspective view as seen from the front left direction of the retractable leash of FIG. 1, according to the present invention.

FIG. 4 is a left elevational side view of the retractable leash of FIG. 1, according to the present invention.

FIG. 5 is a bottom elevational side view of the retractable leash of FIG. 1, according to the present invention.

FIG. 6 is a perspective view of a reel used for winding the leash, in the retractable leash of FIG. 1, according to the present invention.

FIG. 7 is a perspective view of the gentle stop trigger used in the retractable leash of FIG. 1, according to the present invention.

FIG. 8 is a perspective view of the brake lock arm member for causing sudden braking, in the retractable leash of FIG. 1, according to the present invention.

FIG. 9 is a perspective view of a block member cooperating with the brake lock arm member of FIG. 8, for causing sudden braking for the retractable leash of FIG. 1.

FIG. 10 is a perspective view of a gentle braking member cooperating with the gentle stop trigger of FIG. 7, for causing gentle braking for the retractable leash of FIG. 1.

FIG. 11 is an elevational view of the interior mechanism of the retractable leash of FIG. 1, showing a gentle braking member cooperating with the gentle stop trigger of FIG. 7, and also showing a block member cooperating with the brake lock arm member of FIG. 8, for causing sudden braking for the retractable leash.

FIG. 12 is a perspective view of the interior mechanism of FIG. 11, showing a gentle braking member cooperating with the gentle stop trigger of FIG. 7, and also showing a block member cooperating with the brake lock arm member of FIG. 8, for causing sudden braking for the retractable leash.

FIG. 13 is a schematic view of the movement of the brake lock mechanism and cooperating block member of FIG. 11, showing an unlocked position “A” and a locked position “B”.

FIG. 14 is a schematic view of the movement of the gentle braking member and cooperating gentle stop trigger of FIG. 11, showing an unbraked position “C” of the gentle stop trigger and an unbraked position “E” of the gentle braking member, and a braked position “D” of the gentle stop trigger and a braked position “F” of the gentle braking member.

FIG. 15 is a perspective view of the interior of the casing of the retractable leash of FIG. 1, showing a central pin for supporting the reel of FIG. 6.

FIG. 16 is a schematic side view of a connection between the axle of the reel of FIG. 6 and the cord or line usable in the leash of FIG. 1.

FIG. 17 is a schematic side view of an alternative connection between the axle of the reel of FIG. 6 and the cord or line usable in the leash of FIG. 1, having an additional loop of stretchable cord.

### DETAILED DESCRIPTION OF THE INVENTION

If a dog begins to stray from origin, and the owner wants to stop the dog, they have no choice but to push a lock brake button on a typical retractable leash to instantly stop the cord from releasing automatically. However, this can cause a significant stopping force, called a jerk, that makes it very uncomfortable for the dog and the owner/consumer. In some extreme situations, injury on the dog's neck can occur along with injury to the consumer's hand, arm and/or shoulder areas. Thus, there is a need for a gentle stopping retractable leash that slowly and gently stops a consumer's pet without the uncomfortable jerk and possible injury to a dog or consumer during the process.

The present invention, as described more fully hereunder, uses a design for smoothly or gradually braking the unreeling of the line, and includes gentle brakes for stopping the dog much like a bicycle brake. The gentle brakes allow the user to squeeze the trigger lightly or more aggressively to slow and stop the dog's movement without the sudden jerk of traditional retractable leashes. The consumer may ultimately clamp down on the trigger to clamp the pads to the reel instantly for an aggressive stop if needed. Additionally, a sudden braking mechanism is also provided in the present invention as a second stopping mechanism, also described more fully hereunder.

There are numerous benefits in this invention. There are no sudden jerks; there is the ability to train dogs more effectively; there is a reduction in likelihood of a dog/pet injury in neck region; there is a reduction in likelihood of human injury in hand, arm and shoulder region; and the invention allows the user to proactively control the dog or pet movement.

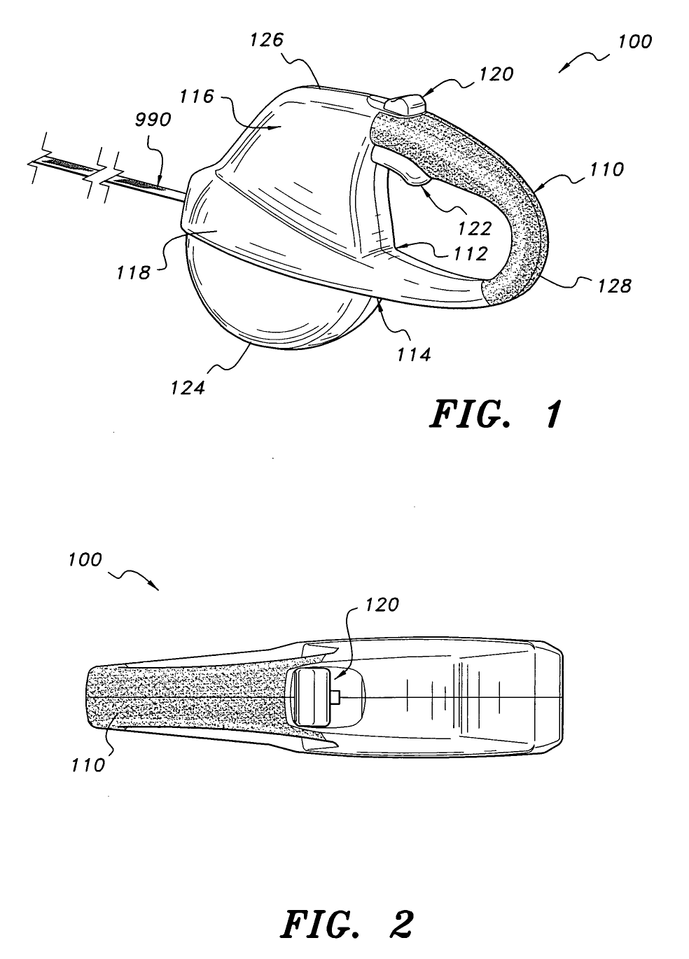

FIG. 1 is perspective view of a retractable leash 100 for gradually slowing unwinding of a cord or line 990. The retractable leash 100 has a casing 116, a brake lock button 120, a gentle stop trigger 122, a handle 110, an upper surface 126, a side surface 118, a lower reel housing surface 124, and a lower handle portion 128. The handle 110 joins the reel casing 116 at junction portions 112 and 114.

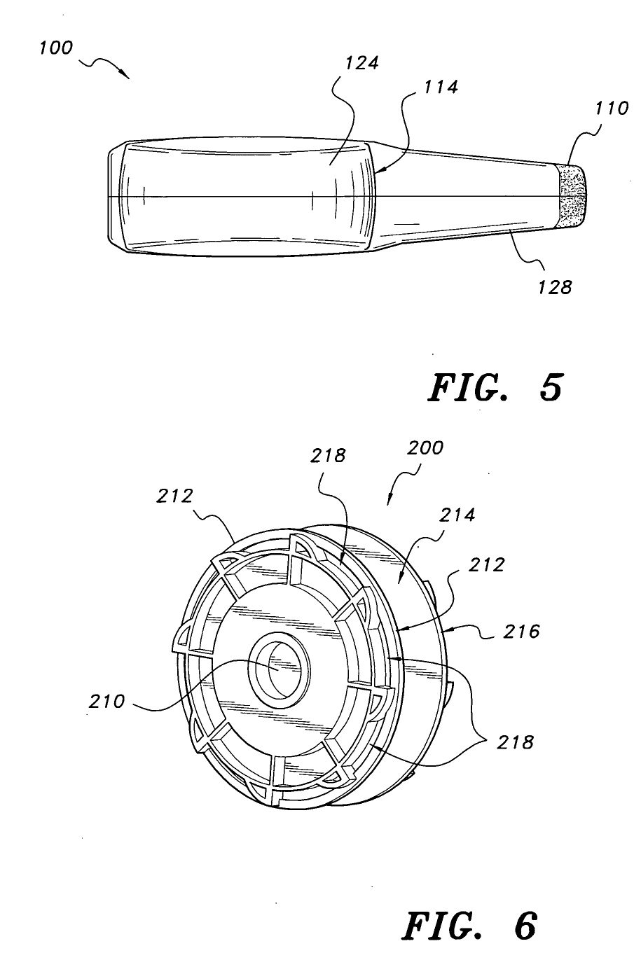

The retractable leash 100 shown in FIG. 1 includes a pet leash reel 200 (shown in FIG. 6) and the exterior casing 116 for housing the reel 600 and the extensible and retractable cord or line 990 (shown broken away in FIG. 1). The handle 110 is preferably formed of a soft grip material or other ergonomic material selected for comfort of the user as well as for strength.

In use, the consumer simply squeezes the gentle stop trigger 122 and the dog or pet will feel resistance and slowly or gradually come to a stop. The consumer can apply a little pressure or can apply a lot of pressure to the gentle stop trigger 122, to stop the dog or pet slowly or quickly.

Also in use, to prevent the dog or pet from moving forward again after completely stopping, the consumer can engage the brake lock button 120 for safety. The consumer simply pushes the brake lock button 120 forward and holds it to lock. The consumer can keep the brake lock button 120 pushed forward to hold it in the locked position. To release the brake lock button 120, the consumer can pull back on the brake lock button 120 completely. While ideally the consumer will be using the gentle stop trigger 122 to gently stop the dog or pet, there may be occasions were it is necessary to make quick stops by using the brake lock button 120 without using the gentle stop trigger 122.

An advantage of the present invention is that it is easy to train the dog or pet to recognize when it is time to stop as well. The consumer simply squeezes the gentle stop trigger 122 lightly to signal the dog to slow or stop. The dog may begin to notice this light resistance and thereby learn it's time to slow or come to a stop. Traditional retractable leashes make it difficult to train dogs to stop because they lock instantly without warning.

FIG. 2 is a top elevational side view of the retractable leash 100 of FIG. 1. This view shows the brake lock button 120, and the top portion of the handle 110.

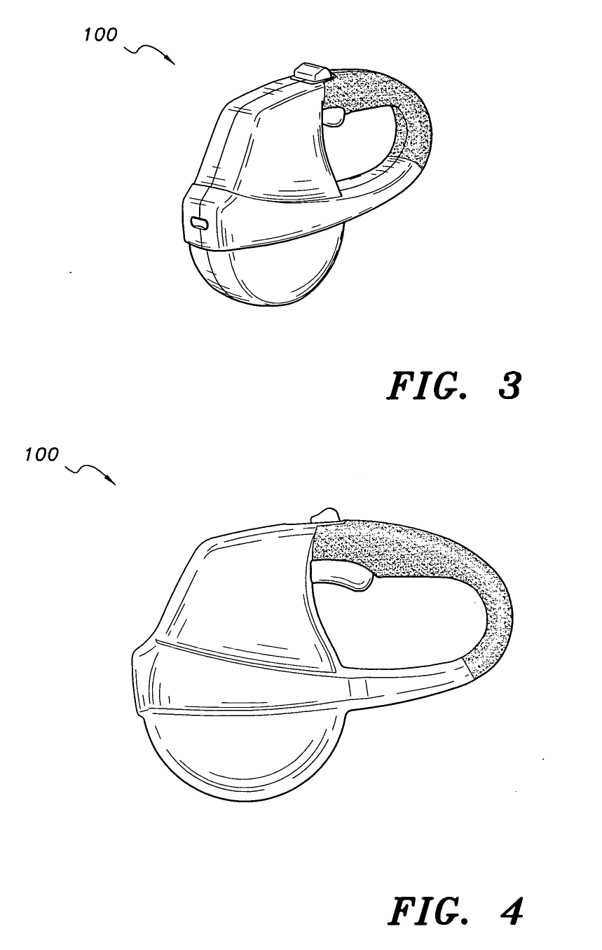

FIG. 3 is a perspective view as seen from the front left direction of the retractable leash 100 of FIG. 1.

FIG. 4 is a left elevational side view of the retractable leash of FIG. 1.

FIG. 5 is a bottom elevational side view of the retractable leash of FIG. 1. Here, the lower reel housing surface 124, lower portion of the handle 110, the lower handle portion 128, and the junction portion 114 are shown.

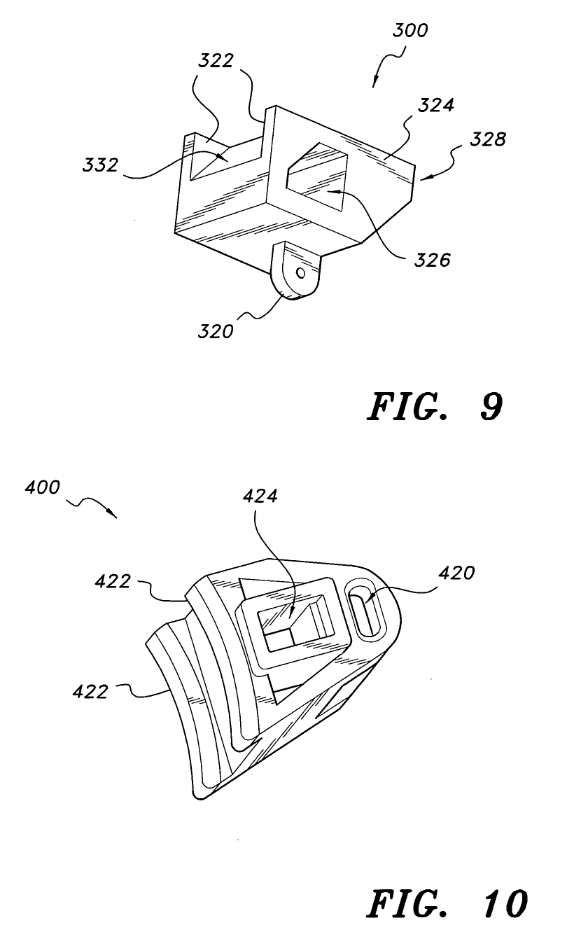

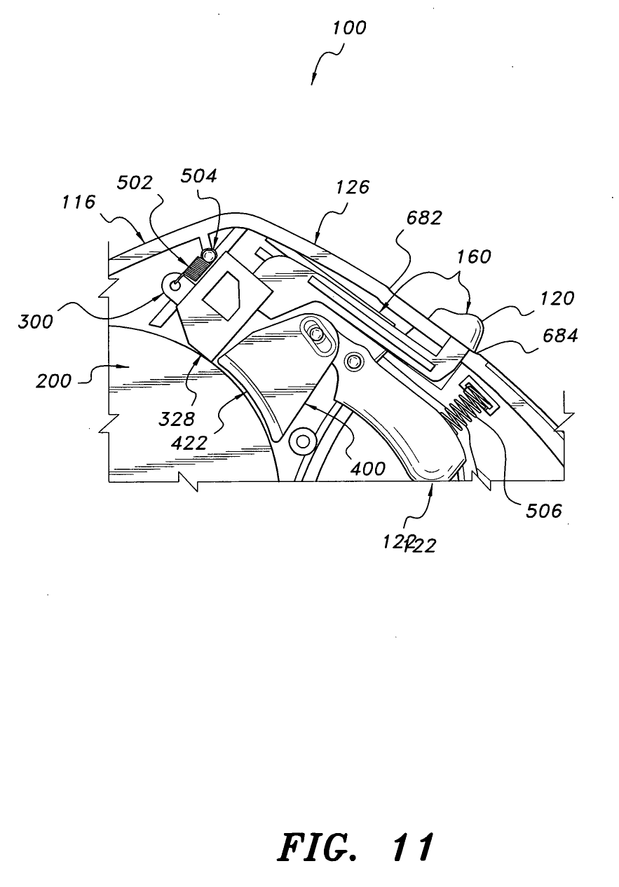

FIG. 6 is a perspective view of the reel 200 used for winding the leash 990 of the retractable leash 100 of FIG. 1. Here, the reel 200 is shown having a central recess 210 for an axle or pin, and a pair of walls 212 and 216 used in typical reel manner for retaining a supply of cord or line 214 therebetween. A plurality of recesses 218 are disposed on the reel 200, to permit stopping engagement with a stopping block 300 (shown in FIG. 9 and discussed below).

The reel 200 has ribbing for strength, but this can be made smooth or solid, of metal or plastic or other appropriate material, and all such variations are within the ambit of skill of anyone skilled in the reel arts.

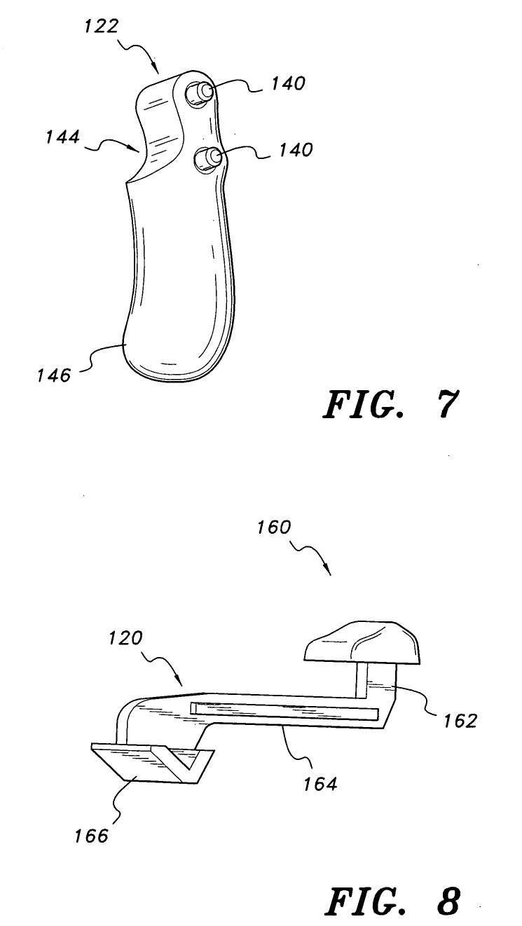

FIG. 7 is a perspective view of the gentle stop trigger 122 used in the retractable leash 100 of FIG. 1. The gentle stop trigger 122 has a main body portion 146, a recess portion 144, and two pins 140 and 142. The pin 142 is used to support the gentle stop trigger 122 for pivoting, while the pin 140 connects the gentle stop trigger 122 to a brake member 400 shown in FIG. 10 and described further hereunder.

FIG. 8 is a perspective view of a brake lock button 120 for causing sudden braking, in the retractable leash 100 of FIG. 1. As shown in FIG. 8, the brake lock button 120 has a button portion 160, a stem 162, an arm portion 164, and a driving end portion 166.

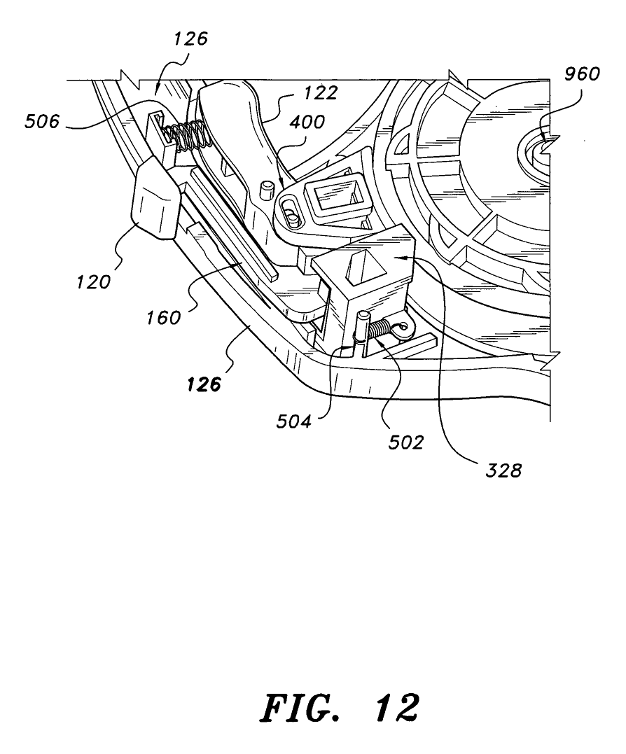

In operation, pushing the brake lock button 120 of FIG. 8 in a forward direction urges the driving end portion 166 into engagement with the block member 300 so that the block member 300 is urged downward into one of the recesses 218 of the reel 200. Release of the brake lock button 120 allows a spring member (shown in FIGS. 11 and 12) to retract the block member 300 from the recesses 218, thereby releasing the reel.

FIG. 9 is a perspective view of a block member 300 cooperating with the brake lock button 120 of FIG. 8, for causing sudden braking for the retractable leash 100 of FIG. 1. The block member 300 has a connecting arm 320, a side wall 324 having a side recess 326, a pair of guide wall portions 322 disposed on either side of an inclined surface 332, and a flat end portion 328. The end portion 166 of the brake lock button 120 of FIG. 8 is received between the pair of guide wall portions 322, for engagement therewith. The block member 300 stops the reel 200 when the block 300 is pushed into one of the recesses 218 in the reel, the recesses being shown in FIG. 6.

FIG. 10 is a perspective view of a gentle braking member 400 cooperating with the gentle stop trigger 122 of FIG. 7, for causing gentle braking for the retractable leash 100 of FIG. 1. The gentle braking member 400 has an end portion having a slot 420; a recessed portion 424 which receives a guide pin (not shown, since conventional in the mechanical arts) to constrain sliding motion of the gentle braking member 400 in a linear direction; and braking surfaces 422, 422.

The braking surfaces 422, 422 can be of any material usable for braking, including plastic, ceramic or rubber. All such variations are within the ambit of skill of anyone having skill in the braking arts, and all such variations are contemplated as being within the scope of the present invention.

FIG. 11 is an elevational view of the interior mechanism of the retractable leash 100 of FIG. 1. In this view, the cooperation of the brake lock button 120 with the block member 300 is shown. The block member 300 is biased away from the reel 200 by a spring member 502 secured to a pin 504 of the reel housing 116. The brake lock button 120 slides in an aperture in the housing which is located between the points 682 and 684 in FIG. 11. The cooperation of the gentle stop trigger 122 with the gentle braking member 400 is also shown, wherein a spring member 506 resiliently urges the end portion of the gentle stop trigger 122 away from the housing 116.

FIG. 12 is a perspective view of the interior mechanism shown in FIG. 11. The parts shown and numbered in FIG. 12 correspond to those shown in FIG. 11.

FIG. 13 is a schematic view of the movement of the fast brake lock mechanism 160 and cooperating block member 300 of FIG. 11, schematically showing an unlocked position “A” and a locked position “B”.

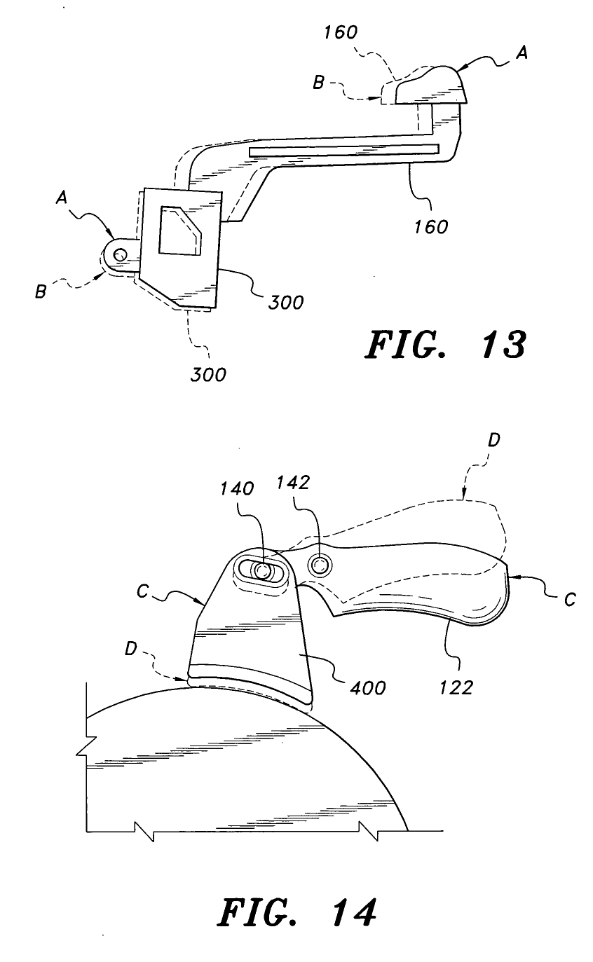

FIG. 14 is a schematic view of the movement of the gentle braking member 400 and cooperating gentle stop trigger 122 of FIG. 11, showing an unbraked position “C” of the gentle stop trigger 122 and an unbraked position “E” of the gentle braking member 400; and also showing a braked position “D” of the gentle stop trigger 122 and a braked position “F” of the gentle braking member 400.

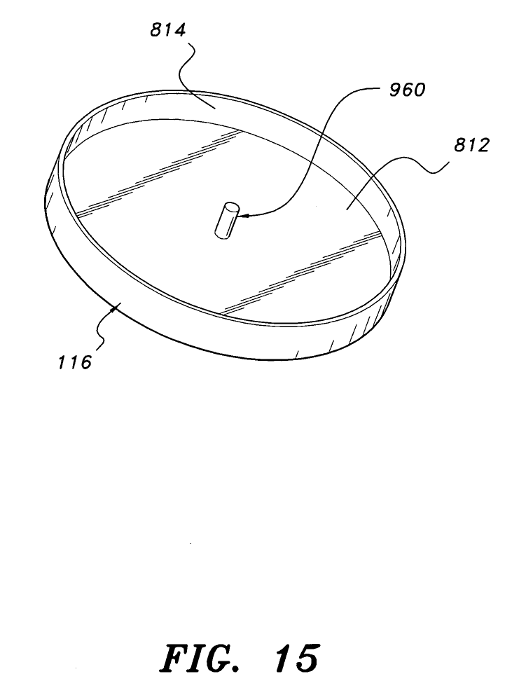

FIG. 15 is a perspective view of the interior of the casing 116 of the retractable leash 100 of FIG. 1, showing a central pin 960 for supporting the reel 200 of FIG. 6. The casing 116 has an upstanding side wall portion 814 and also has a side wall 812.

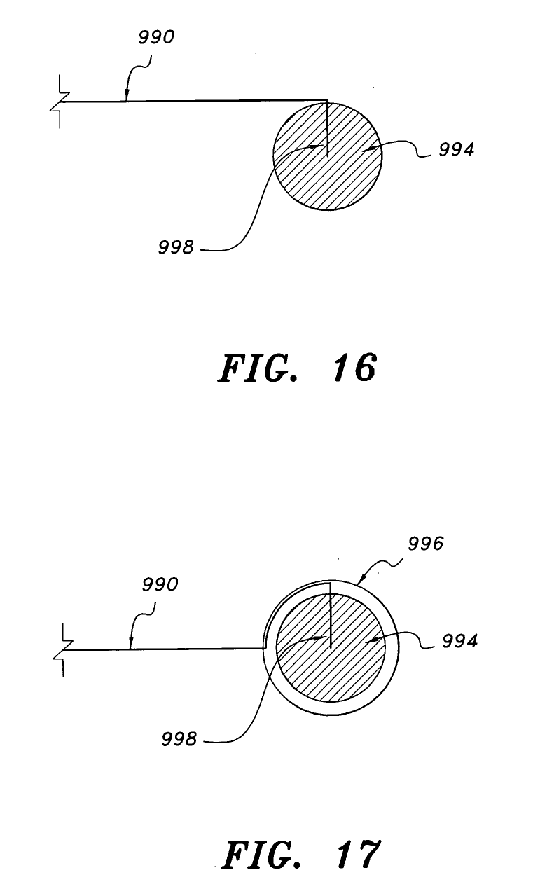

FIG. 16 is a schematic side view of a connection between an axle 994 of the reel of FIG. 6 and the cord or line 990 usable in the leash of FIG. 1. In this embodiment, the axle 994 is an alternative embodiment of the axle of FIG. 6, and has a slit 998 for receiving and holding the end of the line 990.

FIG. 17 is a schematic side view of an alternative connection between the axle 960 of the reel 200 of FIG. 6 and the cord or line 990 usable in the leash of FIG. 1. Here, the axle 994 has a slit as in FIG. 16, but has an additional loop 996 of stretchable cord. In this way, when the line or cord 990 runs out suddenly, as when the owner fails to stop the reel, the line does not jerk the pet to a stop suddenly, due to stretching of the stretchable loop 996.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A retractable leash having a braking mechanism, comprising:
a casing supporting a rotatable reel for winding and unwinding of a retractable cord; and
a braking mechanism for smoothly slowing the unwinding of a retractable cord when a pet is pulling on the cord.

2. A retractable leash having a braking mechanism, comprising:
a casing and rotatable reel for winding and unwinding of a retractable cord;
a first braking mechanism for smoothly slowing the unwinding of the retractable cord when a pet is pulling on the cord, said first braking mechanism including a trigger member and a follower member, such that movement of said trigger member causes movement of said follower member into engagement with said reel to cause braking thereof in proportion to the force applied to said trigger member of said first braking mechanism; and
a second braking mechanism for sudden stops, said second braking mechanism including a manually slideable member and a braking block, whereby movement of said manually slideable member causes movement of said braking block into engagement with said reel to cause a sudden stop of said reel.
